(19) United States
(12) Patent Application Publication
(10) Pub. No.: US 2017/0350978 A1
(43) Pub. Date: Dec. 7, 2017

(54) DEEP WATER SONAR IMAGINING BY MULTIBEAM ECHOSOUNDER

(71) Applicant: Williamson and Associates, Inc., Seattle, WA (US)

(72) Inventors: Michael E. Williamson, Seattle, WA (US); Colin Roy Stewart, Seattle, WA (US); Jeffrey Robert Epler, Seattle, WA (US); Ross Elliott Murray, Seattle, WA (US)

(21) Appl. No.: 15/131,491

(22) Filed: Apr. 18, 2016

(51) Int. Cl. G01S 15/87; B63G 8/38; B63G 8/14; G01V 1/16; B63G 8/00

(52) U.S. Cl. CPC G01S 15/872; G01V 1/168; B63G 8/001; B63G 8/14; B63G 8/38

(57) ABSTRACT

A system for deploying sonar for surveying in deep water includes a submerged movable platform deployed in the deep water at a depth below a thermocline and surface wave action, a propulsion mechanism for moving the platform through the water in a controlled manner, and a multibeam echosounder attached to the platform, wherein the echosounder includes a Mills Cross transmitter and receiver array. A method for deploying sonar for surveying in deep water comprises deploying a submerged movable platform in the deep water at a depth below a thermocline and surface wave action, employing a propulsion mechanism for moving the platform through the water in a controlled manner, and employing a multibeam echosounder attached to the platform, wherein the multibeam echosounder comprises a Mills Cross transmitter and receiver array.

### CROSS REFERENCE TO RELATED APPLICATIONS

Not Applicable

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of sonar imaging in water. More particularly, the disclosure relates to the field of deploying an underwater multibeam echosounder (MBES) for deep water sonar imaging.

Deep water sonar imaging, especially at low-frequencies, is susceptible to signal degradation due to vessel noise sources. Sonar performance can also be degraded by environmental conditions, such as water bottom type, water salinity and temperature. Additionally, signal degradation can be caused by air bubbles or cavitation in the vicinity of the sonar array.

Similarly, signal degradation can be caused by interference from other acoustic or mechanical devices. Auxiliary sensors (such as, for example, a motion sensor, a gyro, or position sensors) can degrade either sounding accuracy or swath width. Performance/swath width can also be degraded by refraction effects or the allowance made for refraction effects.

In general, the lower the acoustic frequency transmitted by a sonar array, the less sonar energy that will be attenuated in seawater. Therefore, for long range systems (such as those used to image and measure the seafloor in very deep water), the longer the wavelength (hence, the lower the frequency), the better the performance. The design of a bathymetric and imaging sonar to be used in ocean depths of 6,000 to 10,000 meters requires transmitted acoustic frequencies of 12 kHz or lower. As a consequence, the sonar arrays operating at these frequencies are physically quite large. To achieve a 2 degree by 2 degree beam pattern at 12 kHz requires a sonar array such as a Mills Cross array with dimensions of about 6 meters by 6 meters. To date sonar systems this large have required mounting on the hulls of vessels.

However, mounting sonar arrays on the hulls of vessels has some disadvantages. An acoustic array directly welded to the ship's hull will pick up flow noise as the vessel moves through the water as well as noise from the engines, generators, deck gear and normal shipboard activities. In heavy weather, bubbles can be entrained beneath the hull as the vessel heaves through the rough seas. These bubbles can mask the sonar signals, requiring that the vessel slow or stop survey operations until weather and sea conditions improve. Sound waves, such as emitted by sonar, travel faster at lower temperatures. Therefore, acoustic energy traveling through a thermocline from a layer of warm water to colder water will be deflected toward the colder, distorting both acoustic imaging and bathymetric measurements. Additionally, temperature gradients are greatest at the sea surface.

The following publications, all from the Institut Francais du Petrole, are representative of conventional apparatuses and methods that may be employed to tow underwater echosounders.

U.S. Pat. No. 4,216,537, issued Aug. 5, 1980 to Robert Delignieres describes towing an echosounder at great depths in the water. Delignieres' '537 patent describes a parametric sonar device transmitting two separate frequencies that when summed, produce a third differential frequency. Supposedly, the lower frequency yields a larger range, while the higher frequency yields better resolution. Delignieres' '537 patent does not describe a configuration of a conventional deep ocean multibeam echosounder transmitter and receiver array typically operating at a single frequency (or sometimes two discrete frequencies, operating independently). However, the present invention is the first to deploy a large Mills Cross multibeam echosounder transmitter and receiver array in a towed configuration.

U.S. Pat. No. 4,220,109, issued Sep. 2, 1980 to Jacques Cholet mentions towing a submerged device, such as an echosounder, in the water. Cholet's patent '109 is for a device to specifically control the varying depth of a towed body by means of a pivoting wing surface. The present application in various embodiments describes a towed body which is intended to maintain a constant depth, controlled by the speed of the towing vessel and the length of an umbilical cable attaching a depressor weight to the vessel. The depth of the depressor and sonar tow body can also be controlled by means of a power winch on the tow vessel which can pay out or retrieve the umbilical cable. The present invention does not employ any movable control surfaces for depth control.

U.S. Pat. No. 4,559,621, issued Dec. 17, 1985 to Robert Delignieres mentions towing at great depths a submerged object that contains an oceanographic apparatus, such as an echosounder. The invention appears to be in a system for determining the position of the towed, submerged object, using transducers positioned on the towing ship. Delignieres' '621 patent describes a short-baseline acoustic positioning system (SBL). Although the patent does discuss improved signal-to-noise ratio, this is in regard to the improved acoustic signals allowing better location of the towed package relative to the towing ship. Today this positioning task is handled with ultra-short baseline (USBL) systems enabled by improved ability to measure very short time intervals very accurately. In the present invention, the improved signal-to-noise ratio from the disclosed configuration will result in improved bathymetry and imagery of the seafloor.

Thus, a need exists for a system and a method for more efficiently and more inexpensively surveying a water bottom in deep water that is not susceptible to low-frequency signal degradation due to noise connected with the survey vessel. Additionally, a need exists for a system and a method for decoupling the motion of the survey vessel from the motion of the echosounder used for surveying.

### SUMMARY

In one aspect, the present disclosure relates to a system for deploying sonar for surveying in deep water, comprising a submerged movable platform deployed in the deep water at a depth below a thermocline and water surface wave action, a propulsion mechanism for moving the platform through the water in a controlled manner, and a multibeam echosounder attached to the platform, wherein the multibeam echosounder comprises a Mills Cross transmitter and receiver array.

In another aspect, the present disclosure relates to a method for deploying sonar for surveying in deep water, comprising deploying a submerged movable platform in the deep water at a depth below a thermocline and surface wave action, employing a propulsion mechanism for moving the platform through the water in a controlled manner, and employing a multibeam echosounder attached to the platform, wherein the multibeam echosounder comprises a Mills Cross transmitter and receiver array.

### BRIEF DESCRIPTION OF THE DRAWINGS

FIG. 1A shows a schematic side view of a general embodiment of a system according to the present disclosure for deploying sonar for surveying in deep water.

FIG. 1B shows a schematic perspective view of the general embodiment of the system shown in FIG. 1A.

FIG. 2 shows a flowchart illustrating an example embodiment of a method according to the present disclosure for deploying sonar for surveying in deep water, using the system shown in FIG. 1.

FIG. 3 shows a schematic perspective view of an embodiment of a towed platform which can be used with a system according to the present disclosure for deploying sonar for surveying in deep water, as shown in FIGS. 1A and 1B.

FIG. 4 shows a flowchart illustrating an embodiment of a method of using a towed platform, as shown in FIG. 3, which can be used in accordance with the preset disclosure for deploying sonar for surveying in deep water, as shown in FIGS. 1A and 1B.

FIG. 5 shows a schematic side view of an embodiment of a propulsion mechanism for towing the platform shown in FIG. 3.

FIG. 6 shows a flowchart illustrating an embodiment of a method according to the present disclosure for employing the propulsion mechanism shown in FIG. 5, for towing the platform shown in FIG. 3.

FIG. 7A shows a schematic perspective view of an embodiment of a multibeam echosounder that can be used with the towed platform shown in FIG. 3 and the propulsion mechanism shown in FIG. 5.

FIG. 7B shows a schematic bottom view of the embodiment of the multibeam echosounder shown in FIG. 7A.

FIG. 8 shows a flowchart illustrating an embodiment of a method according to the present disclosure for deploying the multibeam echosounder shown in FIGS. 7A and 7B.

### DETAILED DESCRIPTION

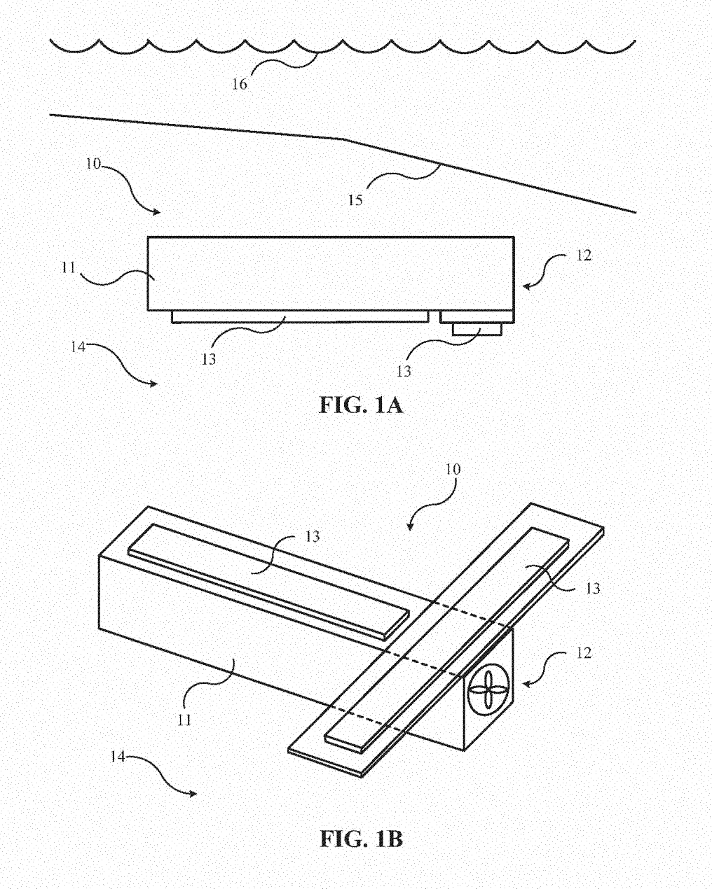

FIG. 1A shows a schematic side view (not necessarily to scale) of an example embodiment of a system according to the present disclosure for deploying sonar for surveying in deep water, such as may be used in the present invention. FIG. 1B shows a schematic perspective view of the example embodiment of the system shown in FIG. 1A. The system is designated in general by the reference numeral 10.

In general, as shown in FIGS. 1A and 1B, the system 10 comprises a submerged movable platform 11, a propulsion mechanism 12, and a multibeam echosounder 13.

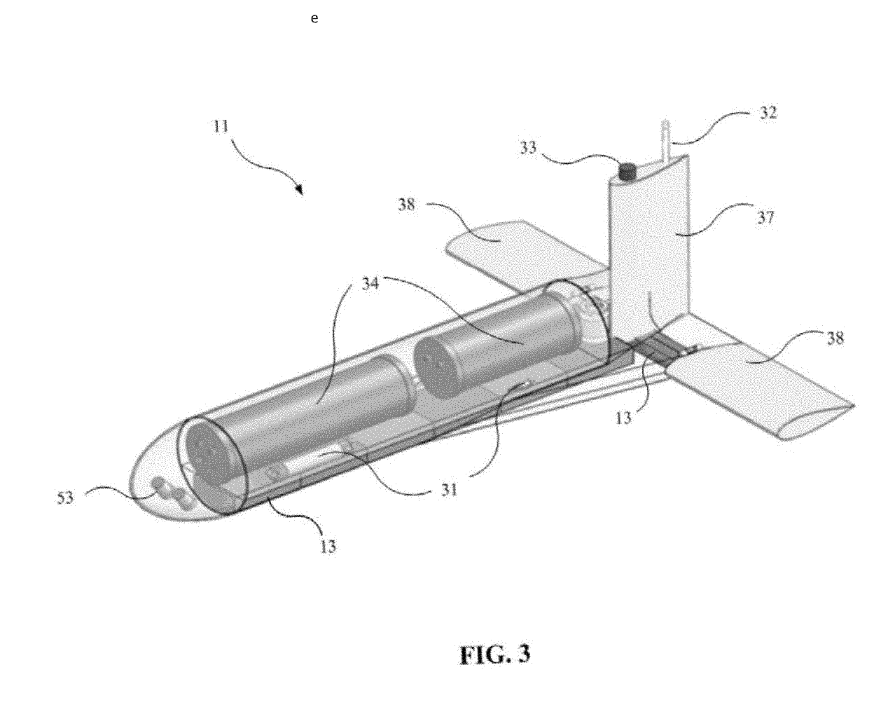

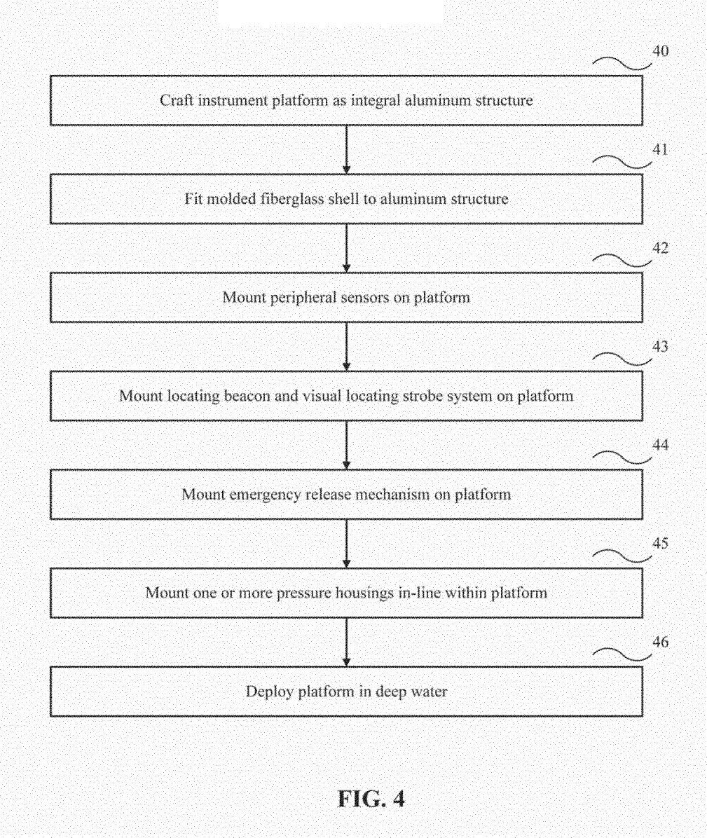

The platform 11 is deployed in deep water 14. The platform 11 is deployed at a depth below a thermocline 15 and surface wave action 16. An exemplary embodiment of a platform 11 is shown in FIG. 3 below and further described in the discussion with respect to FIGS. 3 and 4.

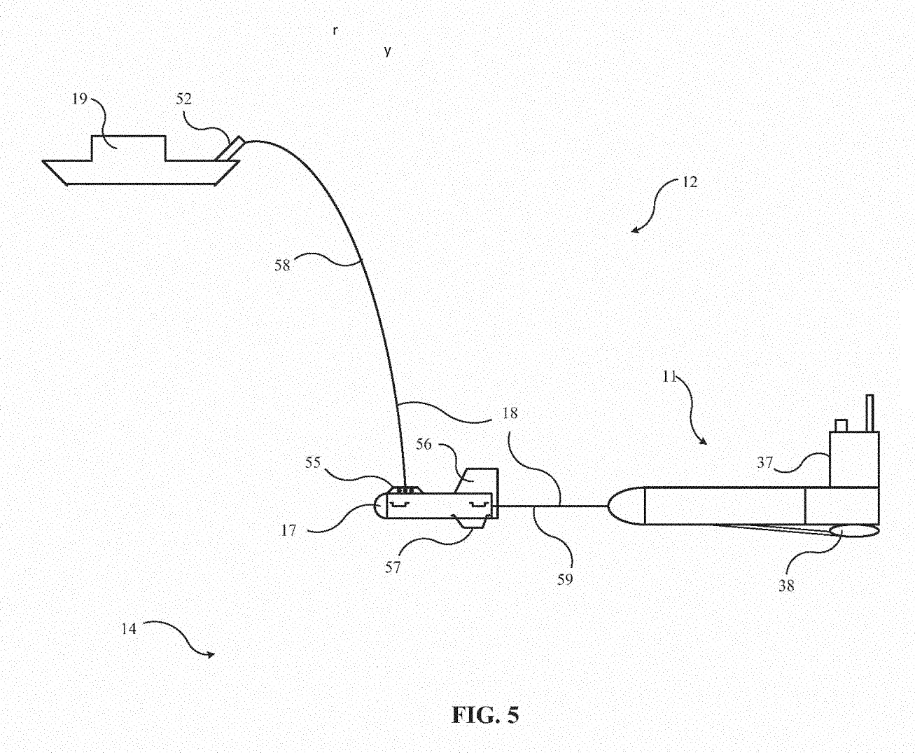

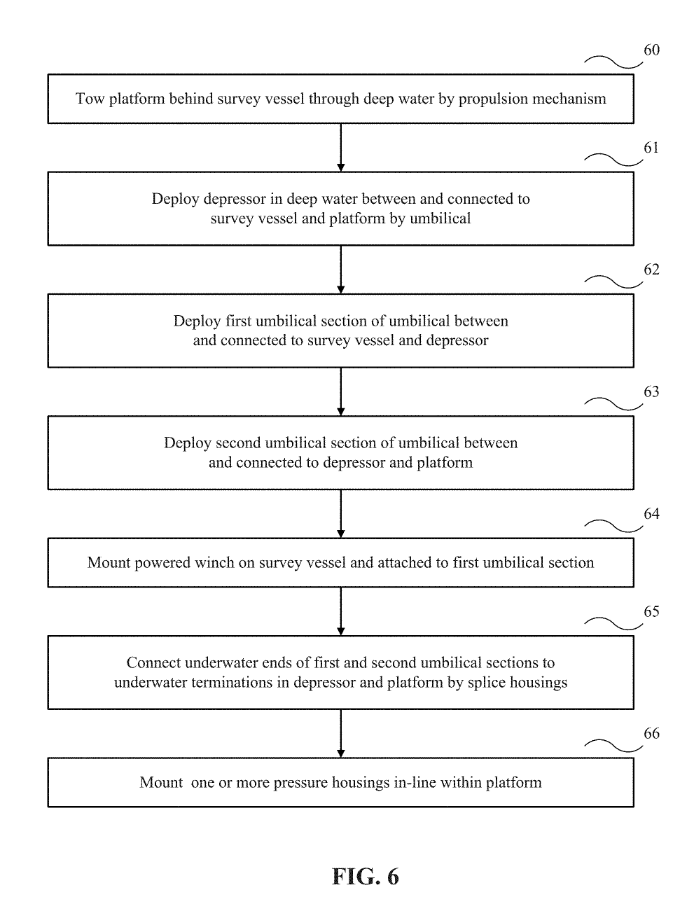

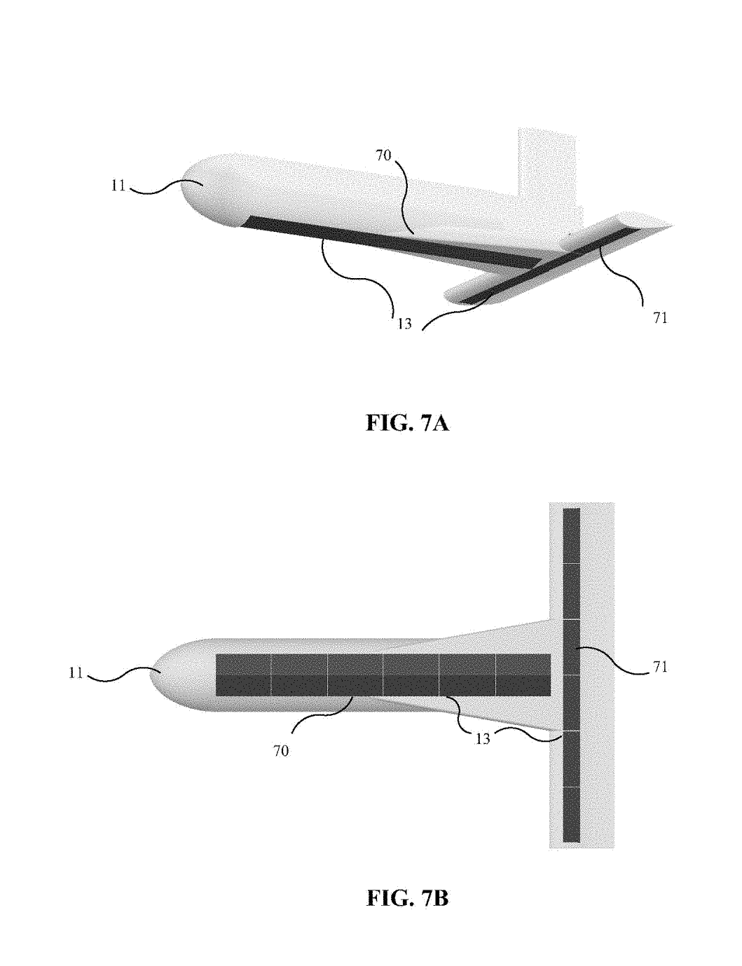

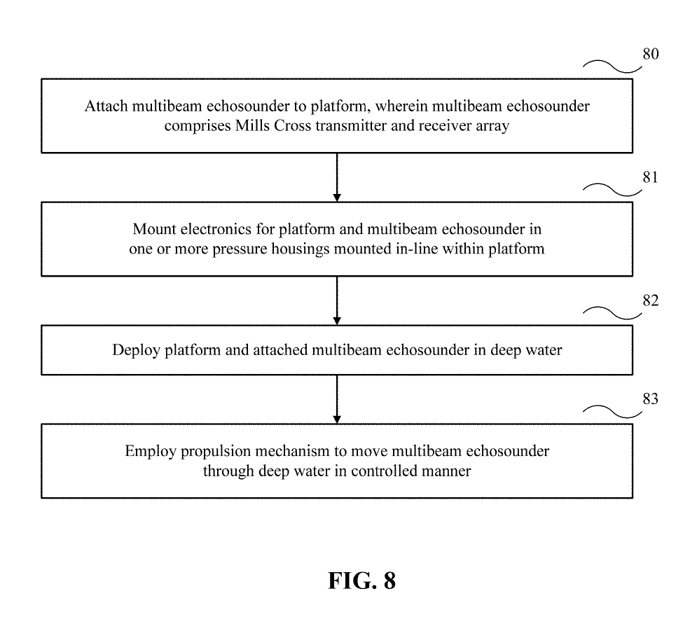

The propulsion mechanism 12 is employed to move the platform 11 through the deep water 14. In particular, the propulsion mechanism 12 is employed to move the platform 11 in a controlled manner. An exemplary embodiment of a propulsion mechanism 12 is shown in FIG. 5 below and further described in the discussion with respect to FIGS. 5 and 6. The multibeam echosounder 13 is attached to the platform 11. The echosounder 13 comprises a Mills Cross transmitter and receiver array. An exemplary embodiment of a multibeam echosounder is shown in FIGS. 7A and 7B below and further described in the discussion with respect to FIGS. 7A, 7B, and 8.

The multibeam echosounder 13, attached to the movable platform 11, is operated at a depth well below the influence of the thermocline 15 and the surface wave action 16. In the present example embodiment in which the propulsion mechanism 12 comprises towing by a survey vessel 19, keeping the platform 11 well below and astern of the survey vessel 19 will effectively decouple the multibeam echosounder 13 from the hull noises of the survey vessel 19. These factors will result in greatly improved performance of the acoustic system and up to about 15 dB reduction in noise relative to a hull-mounted configuration. This is a substantial improvement in sonar performance.

A survey of the water bottom is the primary use of the system 10. The system 10 is best used for surveying with an active acoustic source. However, the acoustic returns are directional, so the system 10 can be adapted to be capable of passive detection and location of remote acoustic sources. These remote acoustic sources include, but are not restricted to, whale songs (useful for identifying migratory routes, inventorying different species, and perhaps tracking individuals), ship noise (propeller cavitation and other noises, particularly useful if acoustic pollution becomes an enforceable offense) and perhaps other uses benefiting from the location of acoustic sources.

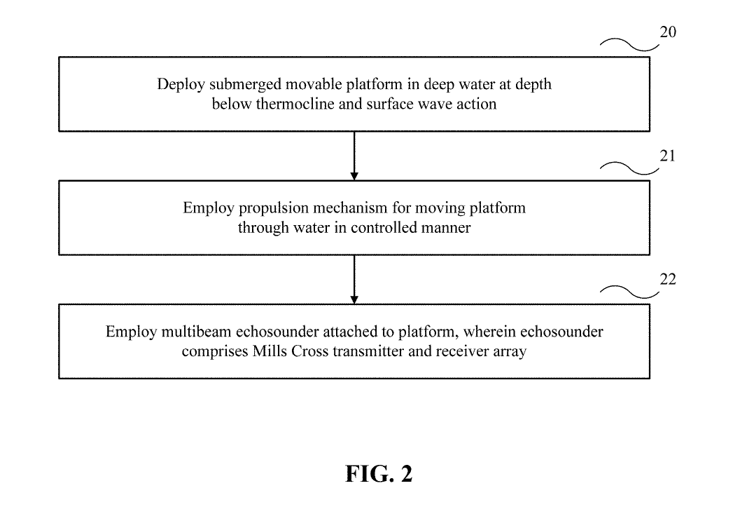

FIG. 2 shows a flowchart illustrating an example embodiment of a method according to the present disclosure for deploying sonar for surveying in deep water. In this embodiment, the method shown in FIG. 2 corresponds to the system shown in FIGS. 1A and 1B above.

At block 20, a submerged movable platform is deployed in the deep water. The platform is deployed at a depth below a thermocline and surface wave action.

At block 21, a propulsion mechanism is employed for moving the platform. The propulsion mechanism moves the platform through the water in a controlled manner.

At block 22, a multibeam echosounder attached to the platform is employed. The echosounder comprises a Mills Cross transmitter and receiver array.

Deepwater multibeam echosounder systems known in the art are mounted on the hulls of surface ships, due to their large size. However, system performance is degraded by noise from ships' engines, generators and flow noise directly coupled through the vessels' hulls.

Installing a standard Mills Cross array in a towed package to be deployed at a nominal depth of about 200 meters, for example, may provide a number of advantages over hull-mounted systems. Advantages of a towed configuration over standard hull-mounts may include the following. Decoupling the sonar arrays from ship motion improves beam steering and data resolution. This is caused by greatly reducing the amount of ship heave and roll communicated to a towed platform. Deployment of the sonar acoustic transducer arrays well below the thermocline minimizes ray path bending, leading to improved imaging range. Isolating the sonar system from ship-generated noise improves the signal-to-noise ratio by permitting significant improvement in range/swath-width. Improvement of the signal-to-noise ratio may be 15 dB or more. Towing the sonar at a depth of about 200 meters permits operation at higher speed during bad weather. Entrained bubbles under the survey vessel hull can degrade performance, requiring a speed reduction from 7-8 knots to 1-2 knots. If the survey vessel can maintain speed while isolating the effects of entrained bubbles on the sonar, sonar performance may be only minimally affected. A towed system can be moved from ship to ship with relative ease, whereas hull-mounted systems require dry docking of the vessel to remove or install the system. Therefore, a towed configuration can be considered a portable system, while the hull-mounted sonar is a ship-specific permanent installation.

FIG. 3 shows a schematic perspective view (not necessarily to scale) of an embodiment of a towed platform which can be used with the system described above for deploying sonar in deep water, as shown in FIGS. 1A and 1B.

In one embodiment in which the submerged movable platform 11 is a towed platform 11, the platform 11 includes systems to provide a neutrally buoyant platform 11 on which to mount the multibeam echosounder 13. This embodiment of the propulsion mechanism 12 is shown in FIG. 5 below and further described in the discussion with respect to FIGS. 5 and 6.

In FIG. 3, an embodiment of the platform 11 suitable for towing is shown. An instrument platform 11 is crafted as an integral structure 35. In an example embodiment, the integral structure 35 is composed of aluminum. However, in other embodiments the integral structure 35 can be composed of suitable composite materials. A shell 36 is fitted to the integral structure 35 to allow removal of sections of the shell 36 for access to peripheral sensors 31 and other components mounted in the platform 11. In one example embodiment, the shell 36 is composed of molded fiberglass. However, in other embodiments the shell 36 can be composed of ultra-high molecular weight polyethylene (UHMW) or suitable composite materials. Various peripheral sensors 31 mounted on the platform 11 will provide information such as attitude, depth, and position. In particular, the peripheral sensors 31 include, but are not restricted to, attitude and position sensors, a depth sensor, and a sound velocity probe. For recovery assistance in the event of loss of the platform 11 in an intentional or unintentional release, a locating beacon 32 (such as an Iridium locating beacon) and a visual locating strobe system 33 with a depth and light activated strobe may be mounted on the platform 11.

The platform 11 is a custom designed vehicle made to carry the multibeam echosounder 13, all the electronics including, but not limited to, transmitter, receiver, power and telemetry housings and peripheral sensors 31. The platform 11 is preferably non-negatively buoyant with the vertical distance between the center of gravity and the center of buoyancy of the platform 11 maximized, thus producing a maximal righting moment for the platform 11. For additional stability, the platform 11 has a vertical rudder 37 and two horizontal wings 38 at the rear.

Additionally, an emergency release mechanism (not shown) is incorporated into the platform 11 to guard against the platform 11 descending below a maximum depth and against collision of the platform 11 with the seafloor. For example, in an example embodiment, the system 10 will be rated for a maximum depth of the depth rating of the multibeam echosounder 13, which is about 450 meters. The actions occurring during a release event typically include automatically releasing the tow point mechanical connection, cutting the tow point electrical and fiber cables, and releasing a 50 lb. drop weight to give the platform 11 net positive buoyancy.

Methods to activate the emergency release include, but are not limited to, the following three methods. A hydrostatic mechanism is set to actuate the emergency release when the platform 11 exceeds a predetermined depth depending upon the maximum depth of the echoshounder 13. In one embodiment, this activation depth is about 400 meters. An acoustic command from a shipboard transducer and command unit may be used to activate the emergency release. A hardwired emergency release allows an operator to manually register a release command that will be telemetered to the platform 11.

One or more pressure housings 34 are mounted in-line within the platform 11. The pressure housings 34 contain power, communications, and electronics for the multibeam echosounder 13. and the platform 11. In another embodiment, the pressure housings 34 can aid in providing positive buoyancy to the platform 11.

Also shown are splice housings 53. Their purpose is described with reference to FIG. 5 and FIG. 6 below.

FIG. 4 shows a flowchart illustrating an embodiment of a method of using a towed platform as shown in FIG. 3, which can be used for deploying sonar in deep water, as shown in FIGS. 1A and 1B. In this embodiment, the method shown in FIG. 4 corresponds to the system of the towed platform shown in FIG. 3.

At block 40, an instrument platform is crafted as an integral structure.

At block 41, a shell is fitted to the integral structure to allow access to the platform.

At block 42, various peripheral sensors are mounted on the platform. The sensors provide at least attitude, depth, and position of the platform.

At block 43, a locating beacon and a visual locating strobe system are mounted on the platform.

At block 44, an emergency release mechanism is mounted on the platform.

At block 45, one or more pressure housings are mounted in-line within the platform to contain system power, communications, and electronics.

At block 46, the platform is deployed in the deep water.

FIG. 5 shows a schematic side view (not necessarily to scale) of an embodiment of a propulsion mechanism, such as may be used according to the present disclosure, as shown in FIGS. 1A and 1B. The propulsion mechanism is used for towing the submerged movable platform shown in FIG. 3. In FIG. 5, an example embodiment of a propulsion mechanism 12 is shown.

The platform 11 is adapted to be towed behind a survey vessel 19 through the deep water 14 by the propulsion mechanism 12. The propulsion mechanism 12 shown in FIG. 5 generally comprises a towed platform 11 (shown in FIG. 3), a survey vessel 19, a depressor 17, an umbilical 18, a powered winch 52, and splice housings 53.

The towed platform 11 is deployed in deep water 14. There, the towed platform 11 is connected to and towed by the surface vessel 19.

The depressor 17 is positioned in the deep water 14 between the survey vessel 19 and the towed platform 11. The depressor 17 may be a ballistically-shaped weight. In an example embodiment, the depressor 17 is about 1000 kilograms in mass and has a variable tow point 55, a vertical fin 56, and two skegs 57 to provide stability while in deep water 14 and while on the deck of the survey vessel 19.

The umbilical 18 is attached between the survey vessel 19 and the platform 11 by way of the depressor 17. The umbilical 18 comprises a non-positively buoyant first umbilical section 58 between the survey vessel 19 and the depressor 17 along with a non-negatively buoyant second umbilical section 59 between the depressor 17 and the platform 11. The umbilical 18 may contain an electro-optical cable and a strength member (not shown). The umbilical 18 is used for towing the platform 11 and for providing power and communications to the platform 11. The umbilical 18 will tow the platform 11 behind the depressor 17 for decoupling the vertical motion of the survey vessel 19 from the vertical motion of the towed platform 11.

In order to decouple the vertical motion of the towed platform 11 from the vertical motion of the survey vessel 19, the survey vessel 19 tows the depressor 17 using the first umbilical section 58 of the umbilical 18. In one embodiment, the first umbilical section 58 may be about 1500 meters in length. Likewise, the depressor 17 tows the platform 11 using the second umbilical section 59 of the umbilical 18. In one embodiment, the second umbilical section 54 may be about 50 meters in length.

In the present example embodiment, such as shown, for example, in FIG. 5, vertical motion of the survey vessel 19 is translated into vertical motion of the depressor 17, while little or none of the vertical motion of the depressor 17 is transferred to vertical motion of the platform 11. As a result, the towed platform 11 maintains a straight and level flight though the deep water 14. This stability permits ping-to-ping coherence in the transmitted and received signals and thus high quality data.

The powered winch 52 is mounted on the survey vessel 19 and attached to the first umbilical section 58. In one embodiment, the powered winch 52 is a direct drive winch.

The splice housings 53 (shown in FIG. 3) are machined Pressure Balanced, Oil Filled (PBOF) housings. The splice housings 53 are provided for underwater termination of an end of the first umbilical section 58 in the depressor 17, of an end of the second umbilical section 59 in the depressor 17, and an end of the second umbilical section 59 in the platform 11.

One or more large pressure housings 34 (shown in FIG. 3) are mounted in-line within the platform 11 and are rated to a maximum water depth of the length of the first umbilical section 58. In an example embodiment, the length of the first umbilical section 58 may be about 1500 meters. The overall system will have a rating of 450 meters based upon the rating of the transmitter and receiver arrays. All other components will be rated to about 1500 meters water depth as a failsafe against accidental submergence to the limits of the length of the first umbilical section 58. The pressure housings 34 also contain and protect electronics for the system 10.

FIG. 6 shows a flowchart illustrating an embodiment of a method for employing a propulsion mechanism, such as may be used in accordance with the present disclosure. The propulsion mechanism shown in FIG. 5 is employed to tow the platform shown in FIG. 3. In this embodiment, the method shown in FIG. 6 corresponds to the system shown in FIG. 5 above.

At block 60, a platform is towed behind a survey vessel through the deep water by a propulsion mechanism.

At block 61, a depressor is deployed in the deep water between and connected to the survey vessel and the platform by an umbilical.

At block 62, a first umbilical section of the umbilical is deployed between and connected to the survey vessel and the depressor.

At block 63, a second umbilical section of the umbilical is deployed between and connected to the depressor and the platform.

At block 64, a power winch is mounted on the survey vessel and attached to the first umbilical section.

At block 65, splice housings connect ends of the first and second umbilical sections to underwater terminations in the depressor and platform.

At block 66, one or more pressure housings are mounted in-line within the platform. The pressure housings contain and protect electronics, in particular, for the platform and multibeam echosounder systems. In another embodiment, the pressure housings can also provide positive buoyancy to aid flotation of the platform.

FIG. 7A shows a schematic side view (not necessarily to scale) of an embodiment of a multibeam echosounder that can be used with the towed platform shown in FIG. 3. FIG. 7B shows a schematic perspective view of the embodiment of the multibeam echosounder shown in FIG. 7A. A multibeam echosounder 13 is attached to the platform 11.

In an example embodiment, the multibeam echosounder 13 is a Mills Cross transmitter and receiver array. In one example embodiment, the multibeam echosounder 13 is a customized Teledyne Reson SeaBat 7150-B sonar. In one example embodiment, the multibeam echosounder 13 is operated with a maximum transmitter frequency of 12 kHz and with a minimum array length of 6 meters to provide a beam width of 2°×2°. The present example embodiment multibeam echosounder 13 is used for the primary purpose of deep ocean surveying.

The electronics for the multibeam echosounder 13 are mounted in the one or more pressure housings (shown in FIG. 3). In an example embodiment, there are two pressure housings. The first pressure housing contains electronic components including, but not limited to, the transmitter power supply, electronics, amplifiers, and capacitor banks. The second pressure housing contains electronic components including, but not limited to, the receiver electronics along with the overall system power supplies, and fiber optic telemetry multiplexers. Other electrical systems on the platform 11 are power and communications. 240 V AC power is provided to the platform 11 for distribution to various DC power supplies.

A fiber optic multiplexer may be used at the surface and subsurface to telemeter data to and from the platform 11. A Continuous Wave Division Multiplexer (CWDM) allows for multiple wavelength pairs on the first umbilical section 58 (shown in FIG. 3). One wavelength pair and multiplexer pair are dedicated to the multibeam echosounder, while one wavelength pair and multiplexer pair are dedicated to the peripheral communication requirements.

Positioning of the vehicle is by the use of an Ultra-Short-Baseline (USBL) system or equivalent. A trickle charge and trigger to a USBL beacon is on the platform 11.

Connectors and cables between all pressure housings, peripheral sensors (shown in FIG. 3) and arrays have a depth rating of a minimum of the length of the first umbilical section 58. In an example embodiment, this length is about 1500 meters.

The Mills Cross configuration is an acoustic array commonly used in Multibeam Echosounders (MBES). In a Mills Cross array, the array of transmitter elements 70 are aligned perpendicular to the array of receiver elements 71 to create a number of discrete beams, each ensonifying a small area of the seafloor. In acoustics, the relationship between the acoustic wavelength and the effective beam width is dependent upon the array diameter (or in this case, the array length). Essentially, the longer the array, the narrower the formed beam projected 90 degrees from the long axis.

FIG. 8 shows a flowchart illustrating an embodiment of a method according to the present disclosure for deploying the multibeam echosounder shown in FIGS. 7A and 7B. In this embodiment, the method shown in FIG. 8 corresponds to the system shown in FIGS. 7A and 7B above.

At block 80, a multibeam echosounder is attached to a platform. In an exemplary embodiment, the platform is as shown in FIG. 3. The multibeam echosounder may be a Mills Cross transmitter and receiver array.

At block 81, electronics for the multibeam echosounder and the platform are mounted in one or more pressure housings mounted within the platform.

At block 82, the platform and attached multibeam echosounder are deployed in the deep water.

At block 83, a propulsion mechanism is employed to move the platform and attached multibeam echosounder through the deep water in a controlled manner.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A system for deploying sonar for surveying in deep water, comprising:
a submerged movable platform deployed in the deep water at a depth below a thermocline and surface wave action;
a propulsion mechanism for moving the platform through the water in a controlled manner; and
a multibeam echosounder attached to the platform, wherein the multibeam echosounder comprises a Mills Cross transmitter and receiver array.

2. The system of claim 1, wherein the platform comprises:
an integral structure crafted for the platform;
a shell fitted to the integral structure to allow access to the platform;
sensors mounted on the platform to provide at least attitude, depth, and position of the platform;
an emergency release mechanism mounted on the platform to prevent the platform from exceeding a maximum depth and to prevent the platform from colliding with the water bottom; and
one or more pressure housings mounted in-line within the platform to contain power, communications, and electronics for the multibeam echosounder and the platform.

3. The system of claim 2, wherein
the transmitter and receiver array has a minimum length of 6 meters;
the transmitters have a maximum transmit frequency of 12 kHz,
a beam pattern of the transmitter and receiver array has a maximum beam width of 2×2 degrees; and
the maximum depth is the maximum depth rating of the transmitter and receiver array.

4. The system of claim 1, wherein the propulsion system comprises:
a survey vessel deployed on the deep water;
a platform deployed in the deep water and towed by the survey vessel;
an umbilical, containing a strength member and an electro-optic cable, attached between the survey vessel and the platform, for towing the platform and for providing power and communications to the platform;
a depressor attached to the umbilical between the survey vessel and the platform for decoupling the vertical motion of the platform from the vertical motion of the survey vessel;
wherein the umbilical comprises:
a first umbilical section attached between the survey vessel and the depressor for towing the depressor and
a second umbilical section attached between the depressor and the platform for towing the platform; and
a powered winch positioned on the survey vessel and attached to the first umbilical section for controlling the length of the first umbilical section in the deep water.

5. The system of claim 4, wherein
the platform is non-negatively buoyant;
the first umbilical section is non-positively buoyant;
the second umbilical section is non-negatively buoyant;
the first umbilical section has a length sufficient to maintain the deployed depth of the platform;
electrical connectors, cables, and the one or more pressure housings have a minimum depth rating of the length of the first umbilical section;
the depressor contains splice housings for the terminations of the umbilical and the tow cable; and
the powered winch is a direct drive winch.

6. The system of claim 1, wherein the multibeam echosounder is used as an active sonar source for a survey of a water bottom.

7. The system of claim 1, wherein the receiver array of the multibeam echosounder is used for passive detection and location of remote acoustic sources.

8. The system of claim 1, wherein the propulsion mechanism comprises towing by a survey vessel.

9. The system of claim 1, wherein the propulsion mechanism comprises employment of an autonomous underwater vehicle.

10. The system of claim 1, wherein the propulsion mechanism comprises employment of a submarine.

11. A method for deploying sonar for surveying in deep water, comprising:
deploying a submerged movable platform in the deep water at a depth below a thermocline and surface wave action;
employing a propulsion mechanism for moving the platform through the water in a controlled manner; and
employing a multibeam echosounder attached to the platform, wherein the echosounder comprises a Mills Cross transmitter and receiver array.

12. The method of claim 11, wherein deploying the platform comprises:
crafting an integral structure for the platform;
fitting a shell to the integral structure to allow access to the platform;
mounting sensors on the platform to provide at least attitude, depth, and position of the platform;
mounting an emergency release mechanism on the platform to prevent the platform from exceeding a maximum depth and to prevent the platform from colliding with the water bottom; and
mounting one or more pressure housings in-line within the platform to contain power, communications, and electronics for the multibeam echosounder and the platform.

13. The method of claim 12, wherein
the transmitter and receiver array has a minimum length of 6 meters;
the transmitters have a maximum transmit frequency of 12 kHz,
a beam pattern of the transmitter and receiver array has a maximum beam width of 2×2 degrees; and
the maximum depth is the maximum depth rating of the transmitter and receiver array.

14. The method of claim 11, wherein the propulsion system comprises:
deploying a survey vessel on the deep water;
deploying a platform in the deep water and towed by the survey vessel;
attaching an umbilical, containing a strength member and an electro-optic cable, between the survey vessel and the platform for towing the platform and for providing power and communications to the platform;
attaching a depressor to the first umbilical section between the survey vessel and the platform for decoupling the vertical motion of the platform from the vertical motion of the survey vessel;
wherein the umbilical comprises:
a first umbilical section attached between the survey vessel and the depressor for towing the depressor and
a second umbilical section attached between the depressor and the platform for towing the platform; and
attaching a powered winch, positioned on the survey vessel, to the first umbilical section for controlling the length of the first umbilical section in the deep water.

15. The method of claim 14, wherein
the platform is non-negatively buoyant;
the first umbilical section is non-positively buoyant;
the second umbilical section is non-negatively buoyant;
the first umbilical section has a length sufficient to maintain the deployed depth of the platform;
electrical connectors, cables, and the one or more pressure housings have a minimum depth rating of the length of the first umbilical section;
the depressor contains splice housings for the terminations of the umbilical and the tow cable; and
the powered winch is a direct drive winch.

16. The method of claim 11, wherein the multibeam echosounder is used as an active sonar source for a survey of a water bottom.

17. The method of claim 11, wherein the receiver array of the multibeam echosounder is used for passive detection and location of remote acoustic sources.

18. The method of claim 11, wherein the propulsion mechanism comprises towing by a survey vessel.

19. The method of claim 11, wherein the propulsion mechanism comprises employment of an autonomous underwater vehicle.

20. The method of claim 11, wherein the propulsion mechanism comprises employment of a submarine.
